(19) United States
(12) Patent Application Publication
(10) Pub. No.: US 2025/0331444 A1
(43) Pub. Date: Oct. 30, 2025

(54) SALINE-ALKALI ENVIRONMENT MONITORING SYSTEM AND METHOD

(71) Applicant: Institute of Land Engineering and Technology, Shaanxi Provincial Land Engineering Construction Group, Xi'an (CN)

(72) Inventors: Yang ZHANG, Xi'an (CN); Ziru NIU, Xi'an (CN); Juan LI, Xi'an (CN); Lu ZHANG, Xi'an (CN); Hui KONG, Xi'an (CN); Dan WU, Xi'an (CN); Liangyan YANG, Xi'an (CN); Bo WANG, Xi'an (CN); Shenglan YE, Xi'an (CN); Jianglong SHEN, Xi'an (CN); Xiaomei SUN, Xi'an (CN)

(73) Assignee: Institute of Land Engineering and Technology, Shaanxi Provincial Land Engineering Construction Group, Xi'an (CN)

(21) Appl. No.: 19/261,733

(22) Filed: Jul. 7, 2025

Related U.S. Application Data
(63) Continuation of application No. PCT/CN2023/130082, filed on Nov. 7, 2023.

(30) Foreign Application Priority Data
Sep. 26, 2023 (CN) 202311254413.8

(51) Int. Cl. A01B 79/00

(52) U.S. Cl. CPC A01B 79/005

(57) ABSTRACT

The present disclosure discloses a saline-alkali environment monitoring system and method, which belongs to the technical field of environmental monitoring. The system includes: a data collection component, a processor and a controller. The data collection component includes: an environment collector. The processor includes: a risk identification unit, a strategy storage unit, a strategy matching unit, a strategy decomposition unit and a strategy optimization unit. This application executes control tasks through the controller. After the controller completes the control tasks, the environment collector collects secondary environment data. The strategy optimization unit optimizes and updates the corresponding risk handling strategies based on the environment data and the secondary environment data, thereby improving the accuracy of saline-alkali environment control.

### CROSS-REFERENCE TO RELATED APPLICATION

This application is a continuation of International Application No. PCT/CN2023/130082, filed on Nov. 7, 2023, which claims priority to Chinese Patent Application No. 202311254413.8, titled “SALINIZATION ENVIRONMENT MONITORING CONTROL SYSTEM AND METHOD” and filed to the China National Intellectual Property Administration on Sep. 26, 2023, the entire contents of which are incorporated herein by reference.

### TECHNICAL FIELD

The present disclosure relates to the field of environmental monitoring technology, particularly to a saline-alkali environment monitoring system and method.

### BACKGROUND

With the advancement of agricultural science and technology, the application of environmental monitoring in agriculture has become increasingly widespread. In recent years, the ecological problems caused by land saline-alkali, such as the degradation of cultivated land, have become increasingly serious. Therefore, it is necessary to research on monitoring of crop cultivation and experiments in saline-alkali environments.

In the existing environmental monitoring technologies, the patent publication number CN116508432A, “Salinized Farmland Drainage Circulation Utilization System and Method”, utilizes a saline-alkali improvement system. It can adjust the application rate of the agent according to the total required dosage and water flow speed, to evenly distribute the liquid saline-alkali improvement agent to the field, save the application cost, and achieve uniform improvement of salinized soil; water and fertilizer integrated system can adjust the fertilization rate according to the total fertilizer requirement and water flow speed, to evenly apply the liquid fertilizer along with the irrigation water to the farmland, achieve water and fertilizer integration, which can effectively reduce surface water pollution in farmland, save fertilization costs, and improve water and fertilizer utilization efficiency; a rice field water layer regulation system can be used to adjust the water and fertilizer management and adjust required field surface water level in growth stage in a timely manner according to a real-time environment data collected by a data acquisition system.

When implementing the system scheme in practice, due to environmental changes, hardware errors of the system, etc., the improvement or adjustment results may deviate from the target results. Therefore, it is necessary to correct the deviation. However, the above existing technologies do not consider this point, and the accuracy of saline-alkali environment control is relatively poor.

### SUMMARY

The present disclosure embodiment provides a saline-alkali environment monitoring system and method to solve the problem that there is no relatively reliable monitoring accuracy for saline-alkali environment monitoring in the existing technology.

On the one hand, the present disclosure provides a saline-alkali environment monitoring system, including: a data collection component, a processor and a controller; the data collection component includes: an environment collector; the processor includes: a risk identification unit, a strategy storage unit, a strategy matching unit, a strategy decomposition unit and a strategy optimization unit.

The environment collector is used to collect environment data.

The risk identification unit is used to obtain risk data based on the environment data.

The strategy storage unit is used to store risk handling strategies.

The strategy matching unit is used to match risk handling strategies based on the risk data to obtain the risk handling strategies to be executed.

The strategy decomposition unit is used to decompose the risk handling strategies to be executed into control tasks.

The controller is used to execute the control tasks.

The environment collector is further used to collect secondary environment data after the controller completes the control tasks.

The strategy optimization unit is used to optimize and update the corresponding risk handling strategy based on the environment data and the secondary environment data.

In one possible embodiment, the saline-alkali environment monitoring system further includes: a data center module; the data center module and the processor both run on a server.

The data center module includes: a data preprocessing unit and a data storage unit.

The data preprocessing unit is used to preprocess the environment data and sending the environment data to the processor.

The data storage unit is used to store the environment data.

In one possible embodiment, the data collection component further includes: a growth collector component.

The growth collector component is used to collect crop growth data.

The data storage unit is further used to store the crop growth data.

The strategy optimization unit is further used to optimize and update the corresponding risk handling strategies based on the environment data, the secondary environment data and the crop growth data.

In one possible embodiment, the saline-alkali environment monitoring system further includes: a management terminal.

The management terminal communicates with the server.

In one possible embodiment, the processor further includes: a decision control unit and a risk alarm unit.

The decision control unit is used to determine whether the controller be able to execute the control task.

When it is determined that it can be executed, the decision control unit is further used to send a confirmation instruction to the strategy decomposition unit, and the strategy decomposition unit is further used to send the control task to the controller after receiving the confirmation instruction.

When it is determined that it cannot be executed, the decision control unit is further used to send an alarm instruction to the risk alarm unit, and the risk alarm unit is used to send risk alarm data to the management terminal after receiving the alarm instruction.

In one possible embodiment, the management terminal includes: a mode switching unit.

The mode switching unit is used to switch the working mode of the saline-alkali environment monitoring system, and the working mode includes: automatic monitoring mode and manual monitoring mode.

In the automatic monitoring mode, the data collection component, the data center module, the processor and the controller run or stop periodically.

In the manual monitoring mode, the data collection component, the data center module, the processor and the controller run or stop upon receiving instructions from the management terminal.

In one possible embodiment, a saline-alkali environment monitoring system further includes: a status monitoring module.

The status monitoring module is used to collect the working status data of the data collection component, the data center module, the processor and the controller, and is used to send the working status data to the management terminal.

In one possible embodiment, the environment collector includes one or more of the environmental sensors.

On the one hand, the present disclosure also provides a saline-alkali environment monitoring method, including the following steps:

Collecting environment data.

Obtaining risk data based on the environment data.

Matching risk handling strategies based on the risk data to obtain risk handling strategies to be executed.

decomposing the risk handling strategy to be executed into control tasks.

Executing the control tasks.

Collecting secondary environment data.

Optimizing and updating the corresponding risk handling strategies based on the environment data and the secondary environment data.

The advantages of the monitoring system and the method for saline-alkali environment in the present disclosure are as below:

The control tasks are executed by the controller. After the controller completes the control tasks, the environment collector collects secondary environment data. The strategy optimization unit optimizes and updates the corresponding risk handling strategies based on the environment data and the secondary environment data, thereby improving the accuracy of the control for the saline-alkali environment. The proposed strategy optimization unit also optimizes and updates the corresponding risk handling strategies based on the environment data, the secondary environment data, and the crop growth data, thereby improving the accuracy of strategy optimization. The proposed decision control unit determines whether the controller can execute the control tasks, thereby improving the control stability. The proposed mode switching unit switches the working mode of the saline-alkali environment monitoring system, thereby improving the flexibility of monitoring. The proposed status monitoring module collects the working status data, thereby improving the stability of the system operation.

### ILLUSTRATED DESCRIPTION

To better illustrate the technical solutions in the embodiments of the present disclosure or the existing technology, the following will briefly introduce the attached figures used in the description of the embodiments or the existing technology. Obviously, the attached figures described below are only some embodiments of the present disclosure. For ordinary technicians in the field, without the need for creative labor, other attached figures can also be obtained based on these figures.

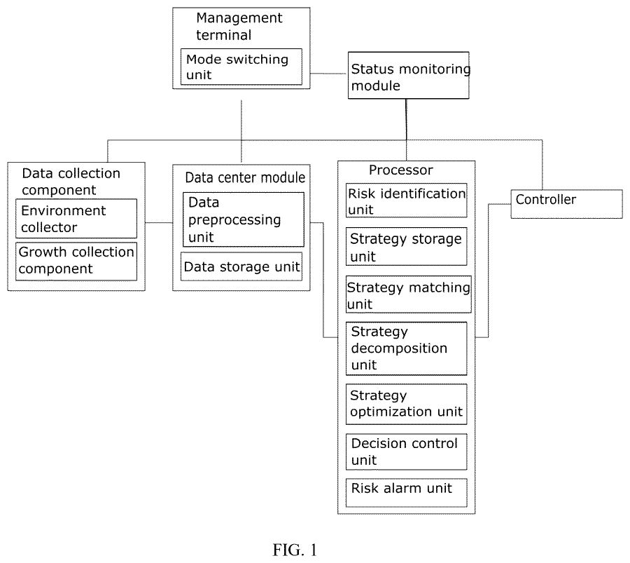

FIG. 1 is a module schematic diagram of a saline-alkali environment monitoring system provided by the embodiment of the present disclosure;

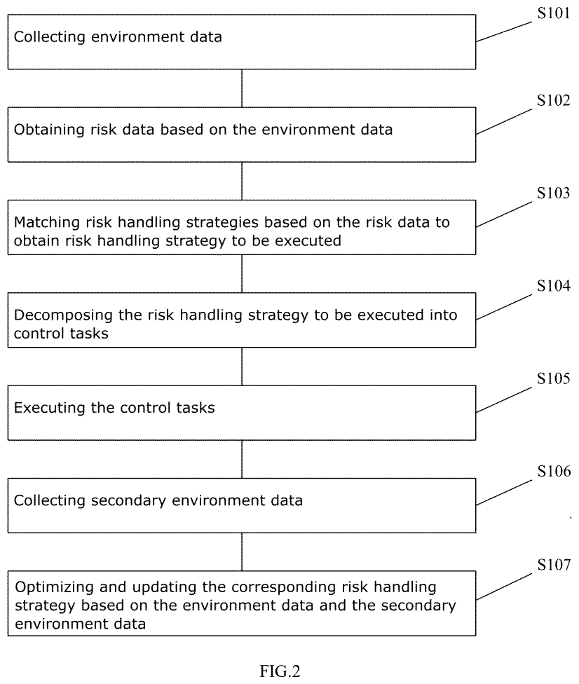

FIG. 2 is a flowchart schematic diagram of a saline-alkali environment monitoring method provided by the embodiment of the present disclosure.

### DETAILED DESCRIPTION

The followings will, in conjunction with the drawings in the embodiments of the present disclosure, clearly and completely describe the technical solution of the embodiments of the present disclosure. Obviously, the described embodiments are only a part of the embodiments of the present disclosure, rather than all the embodiments. Based on the embodiments of the present disclosure, ordinary technicians in the field, without making creative efforts, will obtain all other embodiments, which are all within the protection scope of the present disclosure.

FIG. 1 is a module schematic diagram of the saline-alkali environment monitoring system provided by the embodiment of the present disclosure. A saline-alkali environment monitoring system provided by the embodiment of the present disclosure, includes: a data collection component, a processor and a controller; the data collection component includes: an environment collector; the processor includes: a risk identification unit, a strategy storage unit, a strategy matching unit, a strategy decomposition unit and a strategy optimization unit.

The environment collector is used to collect environment data.

The risk identification unit is used to obtain risk data based on the environment data.

The strategy storage unit is used to store risk handling strategies.

The strategy matching unit is used to match risk handling strategies based on the risk data, and obtain the corresponding risk handling strategy to be executed.

The strategy decomposition unit is used to decompose the corresponding risk handling strategy into control tasks.

The controller is used to execute the control tasks.

The environment collector is further used to collect secondary environment data after the controller completes the control tasks.

The strategy optimization unit is used to optimize and update the corresponding risk handling strategy based on the environment data and the secondary environment data.

Specifically, the risk identification unit is used to obtain the risk data by comparing the environment data with preset risk environment data stored in the risk identification unit. In this embodiment, each type of environment data corresponding to the risk environment data respectively includes two range threshold data, denoted as the first risk range and the second risk range, where the first risk range is included in the second risk range. When the corresponding environment data is within the first risk range, corresponding risk data indicates a low level of risk; when the corresponding environment data is not within the first risk range but within the second risk range (including that greater than the maximum value of the first risk range and less than the minimum value of the first risk range), corresponding risk data indicates a medium level of risk (including the first medium risk and the second medium risk); when the corresponding environment data is not within the second risk range (including that greater than the maximum value of the second risk range and less than the minimum value of the second risk range), the risk data indicates a high level of risk (including the first high risk and the second high risk). In other possible embodiments, other forms of risk environment data and risk data can also be set according to actual needs.

The strategy storage unit is used to store the risk handling strategies, including manually set risk handling strategies and model-calculated risk handling strategies. The model-calculated risk handling strategies are obtained through the establishment of a strategy model using neural networks and sample environment data sets.

The strategy matching unit is used to match the risk handling strategies based on the risk data. The risk handling strategies include irrigation strategies, environmental comprehensive control strategies, soil improvement strategies and fertilization strategies. For example, taking soil moisture as an example, when the environment data corresponding to the soil moisture is compared with the risk environment data and obtained risk data is the first medium risk (i.e., less than the minimum value of the first risk range and within the second risk range, indicating that the soil moisture is low and in a state of soil water shortage), then it matches the risk handling strategy with the first medium risk corresponding to soil moisture (i.e., the soil irrigation strategy in the irrigation strategy) as the corresponding risk handling strategy to be executed. For instance, taking air humidity and CO₂ concentration as examples, when the risk data corresponding to air humidity indicates the first medium risk (i.e., in a state of air water shortage), and the risk data corresponding to CO₂ concentration indicates the second high risk (i.e., in a state of excessive CO₂ concentration), then it matches the corresponding risk handling strategy of air humidity at the first medium risk and CO₂ concentration at the second high risk (i.e., the corresponding strategy in the environmental comprehensive control strategy, including spraying water on the air and ventilation).

Specifically, the controller includes several execution units, which are: one or more than one of an air spraying unit, a soil irrigation unit, a temperature control unit, a light control unit, a risk control unit, a salt and alkali removal unit, and a fertilization unit. In this embodiment, the irrigation strategy corresponds to the air spraying unit and the soil irrigation unit, the soil improvement strategy corresponds to the salt and alkali removal unit, the fertilization strategy corresponds to the fertilization unit, and the environmental comprehensive control strategy corresponds to all the execution units.

The strategy decomposition unit is used to decompose the risk handling strategy to be executed into control tasks. For example, still taking soil humidity as an example, the risk handling strategy corresponding to soil humidity at the first medium risk (i.e., the soil irrigation strategy in the irrigation strategy) is to irrigate the soil, then the corresponding control task is using the soil irrigation unit to irrigate a corresponding amount of water; again, for example, taking air humidity and CO₂ concentration as examples, the risk handling strategy corresponding to air humidity at the first medium risk and CO₂ concentration at the second high risk (i.e., the corresponding strategies in the environment comprehensive control strategies, including spraying water on the air and ventilation) is to spray water and ventilate the air, then it is decomposed into two control tasks, including using the air spraying unit to spray a corresponding amount of water and using the risk control unit to ventilate at a corresponding wind speed.

The strategy optimization unit is used to input the environment data and the secondary environment data into the strategy model to optimize and update the risk handling strategies. Specifically, still taking soil humidity as an example, after the corresponding risk handling strategy for soil humidity at the first medium risk is executed, the secondary environment data of soil humidity is collected. If the difference between the environment data and the secondary environment data is within the preset range (theoretically, after executing a certain risk handling strategy, the variable quantity corresponding to the environment data should be an ideal fixed value or fluctuate slightly around the ideal fixed value, that is, the difference range), it indicates that the corresponding risk handling strategy for soil humidity at the first medium risk is without deviation or has a small deviation, and no optimization and update is needed; if the difference between the environment data and the secondary environment data is not within the preset range (including that greater than the difference range and less than the difference range), it indicates that the deviation of the corresponding risk handling strategy for soil humidity at the first medium risk is large, and the irrigation parameters of this risk handling strategy need to be adjusted. In this embodiment, when the difference between the environment data and the secondary environment data is greater than the difference range, it indicates that the soil irrigation amount of the corresponding risk handling strategy for soil humidity at the first medium risk is excessive, and the irrigation parameters of this risk handling strategy need to be reduced; when the difference between the environment data and the secondary environment data is less than the difference range, it indicates that the soil irrigation amount of the corresponding risk handling strategy for soil humidity at the first medium risk is insufficient, and the irrigation parameters of this risk handling strategy need to be increased. The optimization and update methods for other risk handling strategies are referred to above.

Illustratively, the saline-alkali environment monitoring system further includes: a data center module; the data center module and the processor both run on a server.

The data center module includes: a data preprocessing unit and a data storage unit.

The data preprocessing unit is used to preprocess the environment data and send the environment data to the processor.

The data storage unit is used to store the environment data.

Specifically, the data collection component is connected to a gateway device via a wired connection. The gateway device communicates with the server via 4G, 5G or other remote communication methods, and the gateway device is also connected to the controller via a wired connection. In this embodiment, the data storage unit uses a disk array.

Illustratively, the data collection component further includes: a growth collection component.

The growth collection component is used to collect crop growth data.

The data storage unit is further used to store the crop growth data.

The strategy optimization unit is further used to optimize and update the corresponding risk handling strategies based on the environment data, the secondary environment data and the crop growth data.

Specifically, the growth collection component is using video image cameras, crop growth monitors, etc., and the strategy optimization unit is further used to input the environment data, the secondary environment data and the crop growth data into the strategy model to optimize and update the risk handling strategies. Taking soil moisture as an example, after the corresponding risk handling strategy for the first medium risk is executed, the secondary environment data of soil moisture is collected, and the crop growth data over a period of time is also collected. If the crop growth data is normal, then the risk handling strategy is not optimized and updated; if the crop growth data is abnormal, then it is determined whether the difference between the environment data and the secondary environment data is within the preset difference range:

If the difference between the environment data and the secondary environment data is within the preset difference range, it indicates that the corresponding risk handling strategy for the first medium risk has no deviation or a small deviation, and no optimization and update is needed; if the difference between the environment data and the secondary environment data is not within the preset difference range (including greater than the difference range and less than the difference range), it indicates that the deviation of the corresponding risk handling strategy for the first medium risk is large, and the irrigation parameters of the risk handling strategy need to be adjusted. In this embodiment, when the difference between the environment data and the secondary environment data is greater than the difference range, it indicates that the soil irrigation amount of the corresponding risk handling strategy for the first medium risk is excessive, and the irrigation parameters of the risk handling strategy need to be reduced; when the difference between the environment data and the secondary environment data is less than the difference range, it indicates that the soil irrigation amount of the corresponding risk handling strategy for the first medium risk is insufficient, and the irrigation parameters of the risk handling strategy need to be increased. The optimization and update methods for other risk handling strategies are referred to above.

Illustratively, the saline-alkali environment monitoring system further includes: a management terminal.

The management terminal communicates with the server.

Specifically, the management terminal is using remote terminals such as mobile phones, tablet computers, notebook computers, etc. The management terminal and the server is using a C/S architecture, and the management terminal and the server communicate via 4G, 5G or other remote communication methods.

Illustratively, the processor further includes: a decision control unit and a risk alarm unit.

The decision control unit is used to determine whether the controller can execute the control task.

When it is determined that it can be executed, the decision control unit further be used to send a confirmation instruction to the strategy decomposition unit, and the strategy decomposition unit further be used to send the control task to the controller after receiving the confirmation instruction.

When it is determined that it cannot be executed, the decision control unit further be used to send an alarm instruction to the risk alarm unit, and the risk alarm unit is used to send risk alarm data to the management terminal after receiving the alarm instruction.

Specifically, the decision control unit determines whether the controller can execute the control task by judging whether the controller contains an execution unit corresponding to the control task. If it is fully included, it is judged as being able to execute; if it is not fully included, it is judged as not being able to execute. In this embodiment, the risk alarm data includes: the risk data and operation suggestions.

Illustratively, the management terminal includes: a mode switching unit. The mode switching unit is used to switch working mode of the saline-alkali environment monitoring system. The working modes include: automatic monitoring mode and manual monitoring mode.

In the automatic monitoring mode, the data collection component, the data center module, the processor and the controller run or stop periodically.

In the manual monitoring mode, the data collection component, the data center module, the processor and the controller run or stop upon receiving instructions from the management terminal.

Specifically, in the manual monitoring mode, the management person can manually control the running or stop of the data collection component, the data center module, the processor and the controller through the management terminal, and manually set the risk handling strategies and control tasks.

For example, the saline-alkali environment monitoring system may further include: a status monitoring module.

The status monitoring module is used to collect working status data of the data collection component, the data center module, the processor and the controller, and send the working status data to the management terminal.

Specifically, the status monitoring module communicates with the management terminal through 4G, 5G or other remote communication methods, and the status monitoring module is further used to send a work status abnormal alarm signal to the management terminal when the work status data is abnormal.

For example, the environment collector includes: one or more of environmental sensors.

Specifically, the environmental sensors include: air temperature and humidity sensor, soil temperature and humidity sensor, light sensor, light radiation sensor, CO₂ concentration sensor, soil salinity and alkalinity sensor.

FIG. 2 is a flowchart illustrating the process of a saline-alkali environment monitoring method provided by the embodiment of the present disclosure. The embodiment of the present disclosure also provides a saline-alkali environment monitoring method, which includes the following steps:
S101, collecting environment data.
S102, obtaining risk data based on the environment data.
S103, matching risk handling strategies based on the risk data to obtain risk handling strategy to be executed.
S104, decomposing the risk handling strategy to be executed into control tasks.
S105, executing the control tasks.
S106, collecting secondary environment data.
S107, optimizing and updating the corresponding risk handling strategy based on the environment data and the secondary environment data.

Specifically, between steps S104 and S105, there is also a step: determining, by the decision control unit, whether the controller be able to execute the control task; when it is determined that it can be executed, the decision control unit sends a confirmation instruction to the strategy decomposition unit, and the strategy decomposition unit sends the control task to the controller upon receiving the confirmation instruction, and steps S105, S106, and S107 are carried out successively; when it is determined that it cannot be executed, the decision control unit sends an alarm instruction to the risk alarm unit, and the risk alarm unit sends the risk alarm data to the management terminal upon receiving the alarm instruction, and steps S105, S106, and S107 are no longer carried out.

This embodiment executes the control task through the controller, and after the environment collector completes the control task, it collects the secondary environment data. The strategy optimization unit optimizes and updates the corresponding risk handling strategy based on the environment data and the secondary environment data, thereby improving the accuracy of saline-alkali environment control; the proposed strategy optimization unit also optimizes and updates the corresponding risk handling strategy based on the environment data, the secondary environment data, and the crop growth data, thereby improving the accuracy of strategy optimization; the proposed decision control unit determines whether the controller can execute the control task, thereby improving the stability of control; the proposed mode switching unit switches the working mode of the saline-alkali environment monitoring system, thereby improving the flexibility of monitoring; the proposed status monitoring module collects the working status data, thereby improving the stability of system operation.

Although the preferred embodiments of the present disclosure have been described, those skilled in the art will understand that various modifications and variations can be made without departing from the spirit and scope of the present disclosure. Therefore, the appended claims are intended to cover all such modifications and variations as fall within the scope of the present disclosure. The various modules or steps of the present disclosure can be implemented using general-purpose computing devices, they can be concentrated on a single computing device, or distributed among multiple computing devices that form a network. Optionally, they can be implemented using computer-executable program codes, thereby allowing them to be stored in a storage device and executed by the computing device. In some cases, the steps or modules can be executed in a different order than the one described herein, or they can be divided into individual integrated circuit modules. Thus, the present disclosure is not limited to any specific combination of hardware and software.

Obviously, those skilled in the field can make various modifications and variations to the present disclosure without departing from the spirit and scope of the invention. Therefore, if these modifications and variations fall within the scope of the claims of the present disclosure and its equivalents, the present disclosure also intends to include them.

What is claimed is:

1. A saline-alkali environment monitoring system, comprising: a data collection component, a processor and a controller; the data collection component comprising: an environment collector; the processor comprising: a risk identification unit, a strategy storage unit, a strategy matching unit, a strategy decomposition unit and a strategy optimization unit; wherein
the environment collector is used to collect environment data;
the risk identification unit is used to obtain risk data based on the environment data;
the strategy storage unit is used to store risk handling strategies;
the strategy matching unit is used to match risk handling strategies based on the risk data to obtain risk handling strategies to be executed;
the strategy decomposition unit is used to decompose the risk handling strategies to be executed into control tasks;
the controller is used to execute the control tasks;
the environment collector is further used to collect secondary environment data after the controller completes the control tasks;
the strategy optimization unit is used to optimize and update the corresponding risk handling strategies based on the environment data and the secondary environment data.

2. The saline-alkali environment monitoring system of claim 1, further comprising: a data center module; the data center module and the processor both running on a server; wherein
the data center module comprises: a data preprocessing unit and a data storage unit;
the data preprocessing unit is used to preprocess the environment data and send the environment data to the processor;
the data storage unit is used to store the environment data.

3. The saline-alkali environment monitoring system of claim 2, wherein the data collection component further comprises: a growth collector component;
the growth collector component is used to collect crop growth data;
the data storage unit is further used to store the crop growth data;
the strategy optimization unit is further used to optimize and update the corresponding risk handling strategies based on the environment data, the secondary environment data and the crop growth data.

4. The saline-alkali environment monitoring system of claim 2, further comprising: a management terminal;
the management terminal communicates with the server.

5. The saline-alkali environment monitoring system of claim 4, wherein the processor further comprises: a decision control unit and a risk alarm unit;
the decision control unit is used to determine whether the controller be able to execute the control task;
when it is determined to be able to execute, the decision control unit is further used to send a confirmation instruction to the strategy decomposition unit, and the strategy decomposition unit is further used to send the control task to the controller after receiving the confirmation instruction;
when it is determined not to be able to execute, the decision control unit is further used to send an alarm instruction to the risk alarm unit, and the risk alarm unit is used to send the risk alarm data to the management terminal after receiving the alarm instruction.

6. The saline-alkali environment monitoring system of claim 4, wherein the management terminal comprises: a mode switching unit;
the mode switching unit is used to switch the working mode of the saline-alkali environment monitoring system, the working mode comprises: automatic monitoring mode and manual monitoring mode;
in the automatic monitoring mode, the data collection component, the data center module, the processor and the controller run or stop periodically;
in the manual monitoring mode, the data collection component, the data center module, the processor and the controller run or stop upon receiving the instruction from the management terminal.

7. The saline-alkali environment monitoring system of claim 4, further comprising a status monitoring module; wherein
the status monitoring module is used to collect working status data of the data collection component, the data center module, the processor and the controller, and is further used to send the working status data to the management terminal.

8. The saline-alkali environment monitoring system of claim 1, wherein the environment collector comprises: one or more of the environmental sensors.

9. A saline-alkali environment monitoring method applied on the saline-alkali environment monitoring system of claim 1, comprising:
collecting environment data;
obtaining risk data based on the environment data;
matching risk handing strategies based on the risk data to obtain the risk handing strategies to be executed;
decomposing the risk handing strategies to be executed into control tasks;
executing the control tasks;
collecting secondary environment data;
optimizing and updating the corresponding risk handing strategies based on the environment data and the secondary environment data.

10. The saline-alkali environment monitoring method of claim 9, the saline-alkali environment monitoring system further comprising: a data center module; the data center module and the processor both running on a server; wherein
the data center module comprises: a data preprocessing unit and a data storage unit;
the data preprocessing unit is used to preprocess the environment data and send the preprocessed environment data to the processor;
the data storage unit is used to store the environment data.

11. The saline-alkali environment monitoring method of claim 10, wherein the data collection component further comprises: a growth collector component;
the growth collector component is used to collect crop growth data;
the data storage unit is further used to store the crop growth data;
the strategy optimization unit is further used to optimize and update the corresponding risk handling strategies based on the environment data, the secondary environment data and the crop growth data.

12. The saline-alkali environment monitoring method of claim 10, the saline-alkali environment monitoring system further comprising: a management terminal;
the management terminal communicates with the server.

13. The saline-alkali environment monitoring method of claim 12, wherein the processor further comprises: a decision control unit and a risk alarm unit;
the decision control unit is used to determine whether the controller be able to execute the control task;
when it is determined to be able to execute, the decision control unit is further used to send a confirmation instruction to the strategy decomposition unit, and the strategy decomposition unit is further used to send the control task to the controller after receiving the confirmation instruction;
when it is determined not to be able to execute, the decision control unit is further used to send an alarm instruction to the risk alarm unit, and the risk alarm unit is used to send the risk alarm data to the management terminal after receiving the alarm instruction.

14. The saline-alkali environment monitoring method of claim 12, wherein the management terminal comprises: a mode switching unit;
the mode switching unit is used to switch the working mode of the saline-alkali environment monitoring system, the working mode comprises: automatic monitoring mode and manual monitoring mode;
in the automatic monitoring mode, the data collection component, the data center module, the processor and the controller run or stop periodically;
in the manual monitoring mode, the data collection component, the data center module, the processor and the controller run or stop upon receiving the instruction from the management terminal.

15. The saline-alkali environment monitoring method of claim 12, the saline-alkali environment monitoring system further comprising a status monitoring module; wherein
the status monitoring module is used to collect working status data of the data collection component, the data center module, the processor and the controller, and is further used to send the working status data to the management terminal.

16. The saline-alkali environment monitoring method of claim 9, wherein the environment collector comprises: one or more of the environmental sensors.
